(19) United States
(12) Patent Application Publication
(10) Pub. No.: US 2023/0141130 A1
(43) Pub. Date: May 11, 2023

(54) PHENOLIC STABILIZED FRUIT JUICE AND PREPARATION METHOD THEREOF

(71) Applicants: Zhejiang University Zhongyuan Institute, Zhengzhou City (CN); Zhejiang University, Hangzhou (CN)

(72) Inventors: Zhiqiang Hou, Zhengzhou City (CN); Ziqi Chai, Zhengzhou City (CN); Xipan Shu, Zhengzhou City (CN); Luqin Luan, Hangzhou (CN); Shiguo Chen, Hangzhou (CN); Xingqian Ye, Hangzhou (CN)

(21) Appl. No.: 17/577,117

(22) Filed: Jan. 17, 2022

(30) Foreign Application Priority Data
Nov. 8, 2021 (CN) 202111313062.4

(51) Int. Cl. A23L 2/44; A23L 2/04

(52) U.S. Cl. CPC A23L 2/44; A23L 2/04

(57) ABSTRACT

The present disclosure belongs to the technical field of food processing and provides a phenolic stabilized fruit juice and a preparation method thereof. In the present disclosure, plant RG-I pectin polysaccharide is extracted through an ultra-high pressure technology, and then ultra-high pressure technology is used to promote the interaction of pectin polysaccharides and phenols in fruit juice, improve the stability of phenolic substances in fruit juice, and can improve the bioavailability of phenolic substances in fruit juice. The method of the present disclosure improves the added value of products and solves the problem of low bioavailability of phenolic substances in juice.

### CROSS REFERENCE TO RELATED APPLICATION

This patent application claims the benefit and priority of Chinese Patent Application No. 202111313062.4 filed on Nov. 8, 2021, the disclosure of which is incorporated by reference herein in its entirety as part of the present application.

### TECHNICAL FIELD

The present disclosure relates to the technical field of food processing, in particular to a phenolic stabilized fruit juice and a preparation method thereof.

### BACKGROUND ART

Phenolic compounds are a class of plant secondary metabolites containing one or more hydroxyl groups on the benzene ring. Currently, there are about 8,000 different phenolic substances, including phenolic acids, flavonoids, tannins, lignans and stilbene derivatives, etc. Polyphenols are widely found in plants such as fruits and vegetables or plant-derived foods such as fruit and vegetable juices.

The phenolic compounds in fruit and vegetable juice may have a beneficial effect on the human body by reducing oxidative stress, that is, preventing free radicals from damaging proteins, DNA and lipids. In the human body, oxidation is an important process for generating energy, but sometimes oxygen free radicals have a damaging effect on human cells, such as destroying cell membranes, causing cell mutations, and inactivating anti-proteases in serum. In addition to relying on the body's own antioxidant system, it can also work through exogenous antioxidants. Phenolic compounds can act as antioxidants to scavenge free radicals and reduce the risk of various diseases because of their special activity of phenolic hydroxyl groups. However, current phenolic compounds in fruit and vegetable juices are easily degraded by human digestive enzymes, which greatly affect their absorption and utilization by the human body and restrict the development and utilization of their functional products.

### SUMMARY

The purpose of the present disclosure is to provide a phenolic stabilized fruit juice and a preparation method thereof, which can improve the stability of the phenolic substances in the fruit juice and improve the bioavailability of the phenolic substances in the fruit juice.

In order to achieve the above-mentioned purpose of the present disclosure, the present disclosure provides the following technical solutions.

A method for preparing a phenolic stabilized fruit juice, comprising the following steps:

Mixing pomace with an alkaline solution and performing ultra-high-pressure-assisted auxiliary extraction to obtain a pectin polysaccharide; wherein the ultra-high-pressure-assisted extraction is performed under a pressure of 100 to 600 MPa;

Mixing the pectin polysaccharide with fruit juice corresponding to the species of fruit from which the pomace is made, and performing ultra-high pressure treatment to obtain the phenolic stabilized fruit juice; wherein the ultra-high pressure treatment is performed under a pressure of 200 to 500 MPa.

Preferably, the pomace comprises prickly pear pomace, sea buckthorn pomace, mulberry pomace, or raspberry pomace.

Preferably, an alkali in the alkaline solution comprises sodium hydroxide, sodium carbonate or sodium bicarbonate; pH of the alkaline solution is 8 to 14; and a solid-to-liquid ratio of the pomace to the alkaline solution is 1 g:(20 to 40) mL.

Preferably, a time for the ultra-high-pressure-assisted extraction is 1 to 40 min, and a temperature is 20° C.

Preferably, a dosage ratio of the pectin polysaccharide to the fruit juice is 1 g:(20-100) mL.

Preferably, a time for the ultra-high pressure treatment is 5 to 15 min.

Preferably, the method further comprises, after the ultra-high-pressure-assisted extraction is completed, subjecting the obtained material to solid-liquid separation and then to alcohol precipitation under neutral conditions, and washing and drying the obtained precipitate successively to obtain pectin polysaccharide.

Preferably, an alcohol used in the alcohol precipitation comprises ethanol; wherein the ethanol has a mass fraction of 95%, and the alcohol precipitation time is performed for 12 hours.

Preferably, a reagent used for washing is ethanol with a mass fraction of 95%.

The present disclosure provides a phenolic stabilized juice prepared by the preparation method described in the above technical scheme.

The present disclosure provides a method for preparing phenolic stabilized fruit juice, which comprises the following steps: mixing pomace with an alkaline solution, and performing ultra-high-pressure-assisted extraction to obtain pectin polysaccharide under a pressure of 100 to 600 MPa; mixing the pectin polysaccharide with fruit juice corresponding to the species of fruit from which the pomace is made, and performing ultra-high pressure processing to obtain phenolic stabilized juice; the pressure of the ultra-high pressure processing is 200 to 500 MPa. In the present disclosure, plant RG-I pectin polysaccharide are extracted by using a ultra-high pressure technology, and then the ultra-high pressure technology is used to promote the interaction of pectin polysaccharides and phenols in fruit juice, improve the stability of phenolic substances in fruit juice, thus improving the bioavailability of phenolic substances in fruit juice and the added value of products, and solving the problem of low bioavailability of phenolic substances in juice.

### BRIEF DESCRIPTION OF THE DRAWINGS

FIG. 1 is a graph showing curve for analysis of the simulated digestive stability of polyphenols in fruit juice following different treatments in Examples 1-2 and in Comparative Examples 1-2.

### DETAILED DESCRIPTION OF THE EMBODIMENTS

The present disclosure provides a method for preparing phenolic stabilized fruit juice, which comprises the following steps:

Mixing pomace with an alkaline solution and performing ultra-high-pressure-assisted extraction to obtain a pectin polysaccharide; wherein the ultra-high-pressure-assisted extraction is performed under a pressure of 100 to 600 Mpa;

Mixing the pectin polysaccharide with fruit juice corresponding to the species of fruit from which the pomace is made, and performing ultra-high pressure treatment to obtain the phenolic stabilized fruit juice; wherein the ultra-high pressure treatment is performed under a pressure of 200 to 500 MPa.

In the present disclosure, unless otherwise specified, the raw materials required for preparation are all commercially available products well known to those skilled in the art.

In the present disclosure, the pomace and the alkaline solution are mixed, and ultra-high pressure-assisted extraction is performed to obtain the pectin polysaccharide.

In the present disclosure, the pomace preferably includes one or more of prickly pear pomace, sea buckthorn pomace, mulberry pomace, and raspberry pomace. In the present disclosure, there is no special limitation on the source of the pomace, and the corresponding pomace can be obtained in a way well known in the art. In the embodiments of the present disclosure, the pomace is the residual pomace after the corresponding species of fruit is squeezed. In the present disclosure, the pomace is preferably pomace powder obtained by drying and pulverizing the residual pomace after squeezing the fruit juice. In the present disclosure, there is no special limitation on the particle size of the pomace powder, as long as the pomace powder of appropriate particle size is obtained by a crush method well known in the art.

In the present disclosure, the alkali in the alkaline solution preferably includes sodium hydroxide, sodium carbonate or sodium bicarbonate; the alkaline solution is preferably an aqueous solution of alkali, and the pH of the alkaline solution is preferably 8 to 14, more preferably 12.

In the present disclosure, there is no special limitation on the process of mixing the pomace and alkaline solution, and the mixing process well-known in the art may be used. In the present disclosure, the solid-to-liquid ratio of the pomace to the alkaline solution is preferably 1 g:(20 to 40) mL, more preferably 1 g:(25 to 35) mL.

In the present disclosure, the pressure for the ultra-high-pressure-assisted extraction is 100 to 600 MPa, preferably 200 to 500 MPa, more preferably 300 to 400 MP; the time for the ultra-high-pressure-assisted extraction is preferably 1 to 40 min, more preferably 10 to 30 min, the temperature is preferably 20° C. In the present disclosure, there is special limitation on the ultra-high pressure equipment used for the ultra-high-pressure-assisted extraction, and any equipment known in the art that can meet the above conditions can be used.

In the present disclosure, ultra-high pressure is applied for assisting in extracting pectin in pomace, which can accelerate the release of plant cell walls and improve the yield of pectin.

After the ultra-high-pressure-assisted extraction is completed, the present disclosure preferably further includes: after solid-liquid separation of the obtained materials, alcohol precipitation is performed under neutral conditions, and the obtained precipitate is washed and dried in sequence to obtain the pectin polysaccharide. In the present disclosure, the solid-liquid separation method is preferably filtration. In the present disclosure, there is no special limitation the filtration process, and it can be carried out according to a process well-known in the art.

In the present disclosure, it is preferable to add hydrochloric acid solution to the obtained supernatant to adjust the pH value to 7, and perform alcohol precipitation, after solid-liquid separation. In the present disclosure, there is no special limitation on the concentration of the hydrochloric acid solution, and a hydrochloric acid solution with a concentration well known in the art may be selected to adjust the pH value.

In the present disclosure, the alcohol used in the alcohol precipitation preferably includes ethanol; the mass fraction of the ethanol is preferably 95%; the time for the alcohol precipitation is preferably 12 h; the volume ratio of the alcohol to the volume of the supernatant is preferably 2:1. In the present disclosure, the polysaccharides in the supernatant are separated by alcohol precipitation.

After the alcohol precipitation is completed, the present disclosure preferably filters the obtained materials, and sequentially washes and dried the obtained precipitates to obtain pectin polysaccharides. In the present disclosure, there is no special limitation on the filtration process, and filtration may be carried out according to processes well known in the art. In the present disclosure, the reagent used for washing is preferably ethanol with a mass fraction of 95%. In the present disclosure, there is no special limitation the washing and drying process, as long as the process is well-known in the art. In the embodiment of the present disclosure, the washings is carried out 3 times.

In the present disclosure, the pectin polysaccharide is RG-I pectin polysaccharide.

In the present disclosure, after the pectin polysaccharide is obtained, the pectin polysaccharide and the fruit juice of the pomace corresponding to the species from which pomace is made, and ultra-high pressure treatment is performed to obtain a phenolic stabilized fruit juice. In the present disclosure, there is no special limitation on the source and ingredients of the fruit juice, and all fruit juices corresponding to the pomace obtained according to methods well known in the art can be used.

In the present disclosure, there is no special limitation on the process of mixing the pectin polysaccharide with the fruit juice corresponding to the pomace species, and the mixing can be carried out according to a process well known in the art. In the present disclosure, the dosage ratio of the pectin polysaccharide to the fruit juice is preferably 1 g:(20 to 100) mL, more preferably 1 g:(50 to 80) mL.

In the present disclosure, the pressure for the ultra-high pressure treatment is preferably 200 to 500 MPa, more preferably 400 to 500 MPa, and the time is preferably 5 to 15 min, more preferably 10 min. In the present disclosure, the bonding between the pectin polysaccharides and phenolic substances via the hydrogen bonds by means of ultra-high pressure treatment, thereby improving the stability of the phenolic substances.

The present disclosure provides a phenolic stabilized juice prepared by the preparation method described in the above technical scheme. In the present disclosure, the plant RG-I pectin polysaccharide is extracted through ultra-high pressure technology, and the ultra-high pressure technology is used to promote the interaction between pectin polysaccharides and phenols in fruit juice, and improve the stability of phenolic substances in fruit juice, thus the phenolic substances in the prepared phenolic stabilized juice have excellent stability.

The technical solutions of the present disclosure will be clearly and completely described below with reference to the embodiments of the present disclosure. Obviously, the described embodiments are only a part of the embodiments of the present disclosure, rather than all the embodiments. Based on the embodiments of the present disclosure, all other embodiments obtained by those of ordinary skill in the art without inventive work shall fall within the protection scope of the present disclosure.

### Example 1

After drying and pulverizing the residual pomace after squeezing the prickly pear juice, 2 g of prickly pear pomace powder and 0.05 wt % sodium hydroxide aqueous solution (pH value 12) were mixed according to a solid-to-liquid ratio of 1 g:40 mL. Ultra-high-pressure-assisted extraction was performed under a pressure of 500 MPa, for a time of 10 min, and a temperature of 20° C. The resulting material was filtered and the supernatant was retained; hydrochloric acid solution was added to adjust the pH of the resulting supernatant to 7, and then ethanol precipitation was conducted for 12 h using 95 wt % ethanol, and the added volume of 95 wt % ethanol was twice as the volume of the supernatant. After the precipitation, the precipitate was retained by filtration, and the precipitate was washed with 95 wt % ethanol for 3 times, and dried to obtain prickly pear RG-I pectin polysaccharide

Six grams of prickly pear RG-I pectin polysaccharide was added to 300 mL of prickly pear juice, and the obtained prickly pear juice was subjected to ultra-high pressure treatment under a pressure of 500 MPa for 10 min to obtain phenolic stable-state prickly pear juice.

### Example 2

After drying and pulverizing the residual pomace after squeezing the sea buckthorn juice, 2 g of prickly pear powder and 0.05 wt % sodium hydroxide aqueous solution (pH value 12) were mixed according to a solid-to-liquid ratio of 1 g:40 mL. Ultra-high-pressure-assisted extraction was performed under a pressure of 500 MPa, for a time of 10 min, and a temperature of 20° C. The resulting material was filtered and the supernatant was retained. Hydrochloric acid solution was added to adjust the pH value of the supernatant to 7, and then 95 wt % ethanol was add for precipitation for 12 h, the added volume of 95 wt % ethanol was twice as the volume of the supernatant. After the precipitation was completed, the precipitate was retained by filtration, and the precipitate was washed 3 times with 95 wt % ethanol, and after drying, sea buckthorn RG-I pectin polysaccharide was obtained.

Six grams of sea buckthorn RG-I pectin polysaccharide was added to 300 mL of sea buckthorn juice, and the resulting sea buckthorn juice was subjected to ultra-high pressure treatment under a pressure of 500 MPa for 10 min to obtain phenolic stabilized sea buckthorn juice.

### Comparative Example 1

300 mL of prickly pear fruit juice in Example 1 was subjected to ultra-high pressure treatment under a pressure of 500 MPa and for 10 min to obtain prickly pear juice.

### Comparative Example 2

300 mL of sea buckthorn juice in Example 2 was subjected to ultra-high pressure treatment under a pressure of 500 MPa for 10 min to obtain sea buckthorn juice.

Performance Testing

Simulated digestive stability: The juice obtained in Example 1 and Example 2 was used as the experimental groups, and the juice obtained in Comparative Example 1 and Comparative Example 2 was used as the control groups to analyze the digestive stability of simulated stomach (GD) and intestines (ID).

The Experimental Method was:

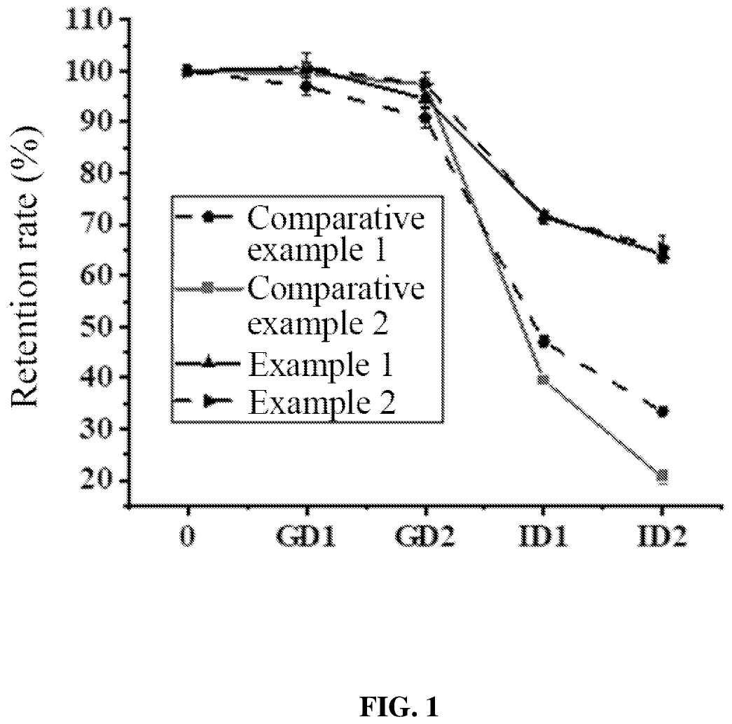

Each sample was divided into four groups (groups were numbered 1, 2, 3, and 4). For gastric digestion, the pH values of the four groups of samples were adjusted to 3.0 with commercially available hydrochloric acid, pepsin was added to the concentration of pepsin in the final mixture was adjusted to 2000 U mL⁻¹, and the mixture was incubated at 37° C. for 2 h. Samples in groups 1 and 2 were retained as gastric samples at hour 1 and hour 2 after incubation for 1 hour and 2 hours, respectively. The pH values of groups 3 and 4 were adjusted to 7.5 with sodium bicarbonate, and trypsin was added to each tube to adjust the concentration of trypsin in the final mixture to 100 U·mL⁻¹, and incubated at 37° C. for 2 hours. Group 3 and group 4 were kept as intestinal samples at hour 1 and hour 2 after incubation for 1 hour and 2 hours, respectively. The total phenol content was determined for all samples, and the total phenol content was determined by the Folin method. The results obtained are shown in FIG. 1.

FIG. 1 is a graph showing the analysis curve of simulated digestive stability of polyphenols in the juice after different treatments in Examples 1-2 and Comparative Examples 1-2. It can be seen from FIG. 1 that after simulated gastric digestion, the total phenol content of Examples 1-2 and Comparative Examples 1-2 still has a high retention rate, but the retention rate of phenols in Examples 1-2 is significantly higher than that of Comparative Examples 1-2 after simulated intestinal digestion, indicating that ultra-high pressure treatment is conducive to improving the retention rate of phenols in the juice after simulated digestion.

The above are merely the preferred embodiments of the present disclosure. It should be pointed out that several improvements and modifications can be made by those of ordinary skill in the art without departing from the principle of the present disclosure, and these improvements and modifications should also be regarded as the protection scope of the present disclosure.

1. A preparation method for phenolic stabilized fruit juice, wherein the preparation method comprises the following steps:
mixing pomace with an alkaline solution and performing ultra-high-pressure-assisted extraction to obtain a pectin polysaccharide; wherein the ultra-high-pressure-assisted extraction is performed under a pressure of 100 to 600 Mpa;
mixing the pectin polysaccharide with fruit juice corresponding to the species of fruit from which the pomace is made, and performing ultra-high pressure treatment to obtain the phenolic stabilized fruit juice; wherein the ultra-high pressure treatment is performed under a pressure of 200 to 500 MPa.

2. The preparation method according to claim 1, wherein the pomace comprises prickly pear pomace, sea buckthorn pomace, mulberry pomace, or raspberry pomace.

3. The preparation method according to claim 1, wherein the alkali in the alkaline solution comprises sodium hydroxide, sodium carbonate, or sodium bicarbonate; pH of the alkaline solution is 8 to 14; the solid-to-liquid ratio of pomace to the alkaline solution is 1 g:(20 to 40) mL.

4. The preparation method according to claim 1, wherein a time for the ultra-high-pressure-assisted extraction is 1 to 40 min, and a temperature is 20° C.

5. The preparation method according to claim 1, wherein a dosage ratio of the pectin polysaccharide to fruit juice is 1 g:(20 to 100) mL.

6. The preparation method according to claim 1, wherein a time for the ultra-high pressure treatment is 5 to 15 min.

7. The preparation method according to claim 1, wherein the method further comprises, after the ultra-high-pressure-assisted extraction is completed, subjecting the obtained material to solid-liquid separation and to alcohol precipitation under neutral conditions, and washing and drying the obtained precipitate to obtain the pectin polysaccharide.

8. The preparation method according to claim 1, wherein the alcohol used in the alcohol precipitation comprises ethanol and the ethanol has a mass fraction of 95%; and a time of the alcohol precipitation is performed for 12 h.

9. The preparation method according to claim 7, wherein a reagent used for washing is ethanol with a mass fraction of 95%.

10. A phenolic stabilized juice prepared by the preparation method according to any one of claim 1.

11. The preparation method according to claim 5, wherein a time for the ultra-high pressure treatment is 5 to 15 min.

12. The preparation method according to claim 1, wherein the method further comprises, after the ultra-high-pressure-assisted extraction is completed, subjecting the obtained material to solid-liquid separation and to alcohol precipitation under neutral conditions, and washing and drying the obtained precipitate to obtain the pectin polysaccharide.

13. The phenolic stabilized juice of claim 10, wherein the pomace comprises prickly pear pomace, sea buckthorn pomace, mulberry pomace, or raspberry pomace.

14. The phenolic stabilized juice of claim 10, wherein the alkali in the alkaline solution comprises sodium hydroxide, sodium carbonate, or sodium bicarbonate; pH of the alkaline solution is 8 to 14; the solid-to-liquid ratio of pomace to the alkaline solution is 1 g:(20 to 40) mL.

15. The phenolic stabilized juice of claim 10, wherein a time for the ultra-high-pressure-assisted extraction is 1 to 40 min, and a temperature is 20°.

16. The phenolic stabilized juice of claim 10, wherein a dosage ratio of the pectin polysaccharide to fruit juice is 1 g:(20 to 100) mL.

17. The phenolic stabilized juice of claim 10, wherein a time for the ultra-high pressure treatment is 5 to 15 min.

18. The phenolic stabilized juice of claim 10, further comprising, after the ultra-high-pressure-assisted extraction is completed, subjecting the obtained material to solid-liquid separation and to alcohol precipitation under neutral conditions, and washing and drying the obtained precipitate to obtain the pectin polysaccharide.

19. The phenolic stabilized juice of claim 10, wherein the alcohol used in the alcohol precipitation comprises ethanol and the ethanol has a mass fraction of 95%; and a time of the alcohol precipitation is performed for 12 h.

20. The phenolic stabilized juice of claim 18, wherein a reagent used for washing is ethanol with a mass fraction of 95%.
